(19) United States
(12) Patent Application Publication
(10) Pub. No.: US 2025/0049256 A1
(43) Pub. Date: Feb. 13, 2025

(54) PORTAFILTER BASKET CLEANING TOOL FOR AN ESPRESSO MACHINE

(71) Applicant: Steven Monti, Cumberland, RI (US)

(72) Inventor: Steven Monti, Cumberland, RI (US)

(21) Appl. No.: 18/732,840

(22) Filed: Jun. 4, 2024

Related U.S. Application Data
(60) Provisional application No. 63/531,813, filed on Aug. 10, 2023.

(51) Int. Cl. A47J 31/60; B08B 9/087

(52) U.S. Cl. CPC A47J 31/60; B08B 9/087; B08B 2209/08

(57) ABSTRACT

A cleaning tool for cleaning a portafilter basket of an espresso machine is provided. The cleaning tool includes a handle, a mandrel, an attachment, and a receptacle. The handle includes a gripping surface capable of being manually grasped by a user. The mandrel is removably connected to the handle, wherein the mandrel includes an installation surface configured for the placement of a cleaning element. The attachment is connected to the mandrel and includes an installation surface for the installation of the cleaning tool. The receptacle is configured for storage of the cleaning tool when the cleaning tool is in a stored position. The cleaning tool is safe, hygienic, and easy to use which allows a user to efficiently and effectively clean the portafilter basket of the espresso machine.

### CROSS-REFERENCE TO RELATED APPLICATIONS

The present application hereby claims priority to and incorporates by reference the entirety of the disclosures of the provisional application No. 63/531,813 entitled “A PORTAFILTER BASKET CLEANING TOOL FOR AN ESPRESSO MACHINE” filed on 10 Aug. 2023.

### TECHNICAL FIELD

The present invention generally relates to cleaning tools and more particularly, the present invention relates to a hand-held tool for cleaning the portafilter basket of an espresso machine.

### BACKGROUND

Generally, espresso machines brew coffee by forcing pressurized water through a “puck” of ground coffee and a filter to produce a thick, concentrated coffee called espresso. A Typical espresso machine comprises components such as but not limited to a group head, filter, and so on. The group head, also referred to as “espresso machine group”, “brew group”, or “brew head” is a component of the espresso machine that dispenses pressurized water into the filter (or “portafilter”) that holds the coffee grounds to produce the espresso coffee. A portafilter is part of the semi-automatic and automatic espresso machines that hold the ground coffee. The portafilter is a filter basket connected to a handle wherein the handle is configured to be grasped by a user.

Repeated usage of espresso machines requires frequent cleaning of the various components of the espresso machine to ensure a high-quality espresso product. Generally, the portafilter is required to be cleaned frequently to maintain the quality of the espresso drink.

Espresso machines typically are operated at either counter or bar height. The portafilter is positioned below the group head and carries ground coffee in the filter basket. Typically, warm water is received into the filter basket holding ground coffee and the espresso drink is produced. Particularly, residue and grinds will accumulate on the portafilter due to repeated usage of the espresso machine. Cleaning an espresso machine portafilter basket after removing a used espresso coffee puck is a common task in the coffee-making industry. Existing methods typically involve manually wiping the portafilter basket with a towel or utilizing electric-powered spinning devices for cleaning purposes. However, these methods may be inefficient, or require expensive equipment.

Typically, a dirty portafilter basket is cleaned with a towel or rag-like cloth after removing a used coffee puck from the portafilter basket. However, towels or rag-like cloths can provide incomplete cleaning and are time-consuming. Further, storage of towels or rag-like cloths can create sanitary issues thereby providing an unhygienic environment.

Electric-powered spinning devices, such as brush attachments or spinning disks, are designed to be attached to an electric motor for automated cleaning of portafilter baskets. While these devices offer automation, they may not provide sufficient cleaning power to remove stubborn coffee residue effectively. Additionally, some models may be prone to mechanical failures or require frequent maintenance, adding to operational costs and downtime.

Various solutions have been used to clean the portafilter basket of the espresso machine. motorized brushes and scrapers are known in the prior art that spins inside the portafilter basket to remove the coffee puck and leftover coffee matter.

For instance, EP3158901A1 discloses a rotating brush, in particular for the cleaning of coffee machine filters. The rotating brush comprises a central support connectable to a rotating organ and a plurality of cleaning elements connected at one of their ends to the central support itself. Each cleaning element comprises a sheet-shaped body elastically deformable at least for part of its length. In an embodiment, the rotating brush is mounted on the shaft of a motor.

EP2732742A1 discloses a rotating head for the cleaning of a receptacle. The rotating head has a front face comprising an annular portion retracted axially against elastic efforts during insertion of head in a portion of receptacle, where the portion of the receptacle includes diameter lower than that of the front face. The front face includes branches extended radially in a plane from a rotation axle. The annular portion is placed at an axial distance from the axle. The annular portion includes a movable brush placed to be moved in an axial direction in a reversible manner under an effect of force exerted on and toward the brush. the device may comprise an electric motor configured to generate said rotational movement of the head, and means for detecting the applied force capable of actuating the electric motor. In an embodiment, the device may comprise an electric motor configured to generate said rotational movement of the head, and means for detecting the applied force capable of actuating the electric motor.

The shortcomings of the motorized brushes and scrapers are that the portafilter basket is to be kept upside-down during the cleaning process thus the user cannot see and properly control how the portafilter basket gets cleaned. Further, the motorized brushes and scrapers require electricity or battery power and, in some cases, the power source needs to be installed into a countertop. Additionally, motorized brushes and scrapers are expensive and complex in design.

The existing solutions related to cleaning of portafilter basket of espresso machines are ineffective and inefficient. In light of the foregoing, there is a need for a safe, easy-to-use, and quick solution that would allow a person to efficiently and effectively clean the portafilter basket of the espresso machine.

### SUMMARY

It is an objective of the present invention to provide a cleaning tool that effectively and efficiently cleans a portafilter basket of an espresso machine.

Embodiments of the present invention disclose a cleaning tool for cleaning a portafilter basket of a coffee machine; the cleaning tool comprises a handle that includes a gripping surface capable of being manually grasped by a user; a mandrel removably connected to the handle, wherein the mandrel includes an installation surface configured for placement of a cleaning element; an attachment connected to the mandrel, wherein the attachment includes an installation surface that provides an installation surface for the installation of the cleaning tool; and a receptacle, that is configured for storage of the cleaning tool when the cleaning tool is in a stored position.

In an embodiment, the receptacle includes a plurality of cut-out holes to prevent moisture buildup in the cleaning tool.

In an embodiment, a base includes a cleaning texture that enables the user to brush the cleaning element against the surface of the base, to knock off coffee ground buildup.

In an embodiment, the cleaning element is a microfiber cloth that is stitched in shape along stitch lines.

In an embodiment, the mandrel includes a central opening that is configured to be removably connected to a cylindrical connecting element of the handle.

In an embodiment, the mandrel further includes an annular wedge element.

In an embodiment, the attachment includes a protrusion that is configured to be received in the cutout of the mandrel.

In an embodiment, the receptacle includes a top groove that securely holds the handle in place in a stored position.

In an embodiment, the cleaning element is a microfiber cloth that is stitched in shape along stitch lines.

In an embodiment, the base comprises a plurality of ventilation holes to prevent moisture buildup in the cleaning tool.

In an embodiment, the base includes a collar that supports load placement of the cleaning tool.

The present invention provides a cleaning tool for cleaning the portafilter basket of the espresso machine. These and other features and advantages of the present invention will become apparent from the detailed description below, in light of the accompanying drawings

### BRIEF DESCRIPTION OF THE DRAWINGS

FIG. 1 illustrates a front-sectional view of a cleaning tool, according to an embodiment of the invention;

FIG. 2 illustrates various views of a handle of the cleaning tool of FIG. 1;

FIG. 3 illustrates various views of a mandrel of the cleaning tool of FIG. 1;

FIG. 4 illustrates a front perspective view of a base of the cleaning tool of FIG. 1, according to an embodiment of the invention;

FIG. 5 illustrates a front perspective view of a cleaning tool, according to another embodiment of the invention;

FIG. 6 illustrates a front perspective view of a cleaning tool, wherein the cleaning tool is shown disengaged from a receptacle;

FIG. 7 illustrates a front perspective view of a cleaning tool effectively cleaning a portafilter basket, wherein a receptacle is positioned adjacent to the cleaning tool;

FIG. 8 illustrates a front perspective view of a receptacle of the cleaning tool of FIG. 1, according to another embodiment of the invention;

FIG. 9 illustrates a front perspective view of a cleaning element of the cleaning tool of FIG. 1, according to an embodiment of the invention;

FIG. 10 illustrates various views of a base, according to another embodiment of the invention; and

FIG. 11 illustrates a front sectional view of an attachment, according to an embodiment of the invention.

### DETAILED DESCRIPTION

Before describing the present invention in detail, it should be observed that the present invention utilizes a combination of components or processes, which constitutes a cleaning tool for cleaning the portafilter basket of an espresso machine. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

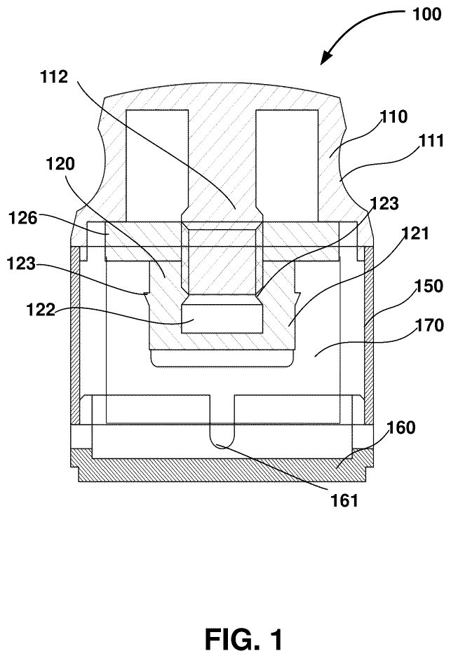

The cleaning tool of various embodiments of the present invention will now be described with reference to the accompanying drawings, particularly FIGS. 1-11.

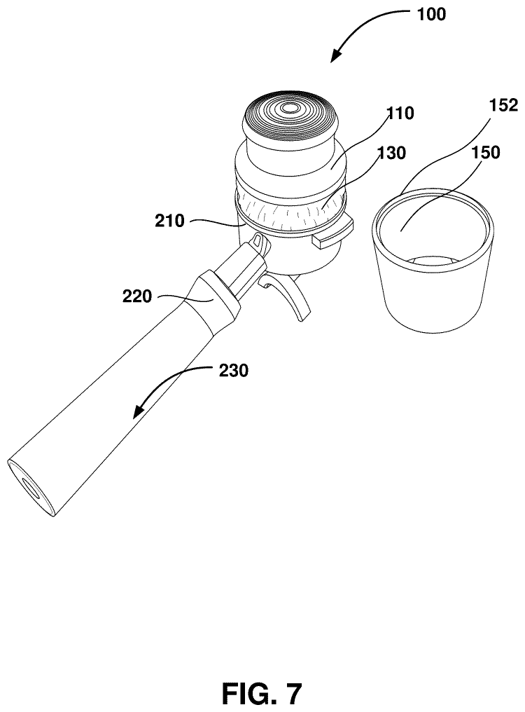

FIG. 1 illustrates a front-sectional view of a cleaning tool 100, according to an embodiment of the invention. The cleaning tool 100 is configured to be used for cleaning a portafilter basket 210 (FIG. 7) of the espresso machine (not shown in figures). The cleaning tool 100 comprises a handle 110, a mandrel 120, a cleaning element 130 (FIG. 7), a receptacle 150, a base 160, and an attachment 170, the entirety of which will be described in greater detail in the below description accompanying figures. The cross-sectional shape of the cleaning tool 100 is substantially circular. In various embodiments (not shown in figures), the cleaning tool 100 may have any other shape of cross section that conforms to the shape of portafilter basket 210 (FIG. 7), including but not limited to rectangle, square, hexagonal, triangle, and so on.

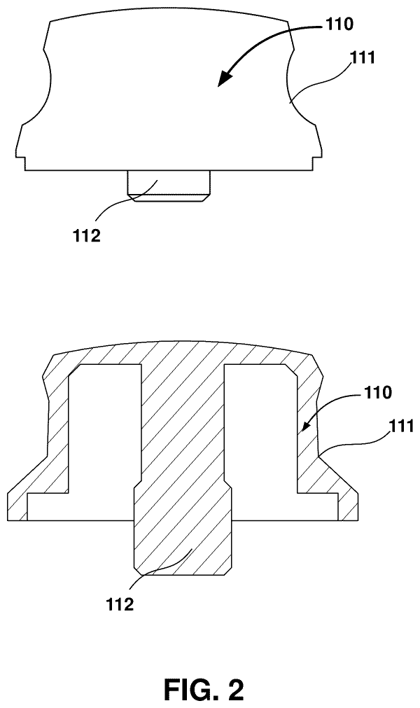

As shown in FIG. 1 and FIG. 2, the handle 110 includes an ergonomic gripping surface 111 capable of being manually grasped by a user. The handle 110 further includes a cylindrical connecting element 112 that is configured to be removably connected to the mandrel 120. The removable connection between the cylindrical connecting element 112 and the mandrel 120 may be achieved using conventional means such as but not limited to screw coupling, snap-fit coupling, luer locks, male-female connector, key and key-ways, magnetic coupling, and so on. The handle 110 may be made of any substantially rigid material, including but not limited to: plastic, wood, metal, silicon, rubber, leather, and so on. In an embodiment seen in FIG. 2, the cylindrical connecting element 112 comprises a plurality of helical threads that are configured to engage with the mandrel 120.

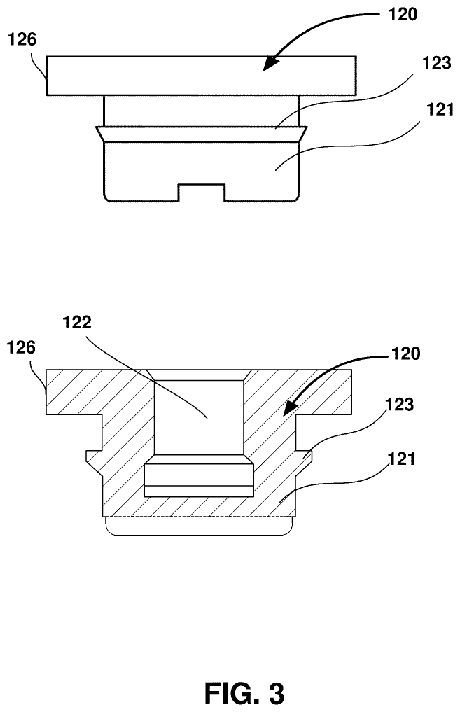

Referring to FIG. 1 and FIG. 3, the mandrel 120 provides an installation surface 126 to allow placement of the cleaning element 130 (FIG. 7) over the installation surface 126. The mandrel 120 includes a central opening 122 that is configured to be removably connected to the cylindrical connecting element 112 of the handle 110. The mandrel 120 further includes an annular wedge element 123 that acts as a shoulder stop for the cylindrical connecting element 112 of the handle 110. The annular wedge element 123 further assists in retaining the cleaning element 130 (FIG. 7) over the installation surface 126 of the mandrel 120. The mandrel 120 further includes a cutout 125 that is substantially cuboidal in shape. The mandrel 120 includes a connection surface 121 that is configured to be received in the attachment 170.

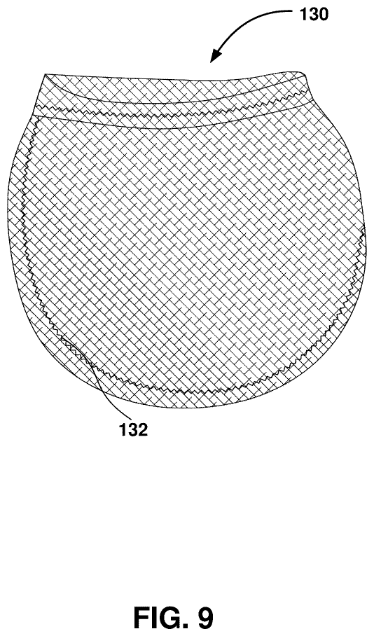

Referring to FIG. 7, the cleaning element 130 is configured to conform and apply force to the areas of the portafilter basket 210 to clean the portafilter basket 210. The cleaning element 130 is made from a conforming material to work effectively with the range of sizes of portafilter basket 210. The cleaning element 130 may include a cylindrical element (sleeve/sock) formed of a material/element including but not limited to microfiber fabrics, terrycloth, nylon bristles, brush, steel wires, polyester brush, cotton, and combinations thereof. As seen in FIG. 7 and FIG. 9, the cleaning element 130 is a microfiber cloth that is stitched in shape along stitch lines 132 that is worn over the installation surface 126 of the mandrel 120 as well as the installation surface 174 of the attachment 170.

Referring back to FIG. 1, the receptacle 150 is configured to be placed over the cleaning element 130 (FIG. 7) in a stored position. The receptacle 150 serves multiple functions. The receptacle 150 is configured to dry and remove coffee material from the portafilter basket 210 (FIG. 7). The receptacle 150 also conforms to the portafilter basket 210 (FIG. 7) in simultaneous action with the cleaning element 130 (FIG. 7), thereby applying force to the areas of the portafilter basket 210 (FIG. 7) to clean the portafilter basket 210 (FIG. 7). In an embodiment, the receptacle 150 is made from an absorbent material such as but not limited to: foam and so on to work effectively with the range of sizes of portafilter basket 210 (FIG. 7). The receptacle 150 includes a top groove 152 that securely holds the handle 110 in place in stored position, preventing it from slipping or falling.

In another embodiment (not shown in figures), the mandrel 120, the cleaning element 130 (FIG. 7), and the attachment 170 are integrally formed (connected) to define a unitary one-piece structure. The unitary one-piece structure may be mounted to a countertop of the espresso machine and motorized using a motor (not shown in figures) to spin (rotate) to clean a portafilter basket 210 (FIG. 7).

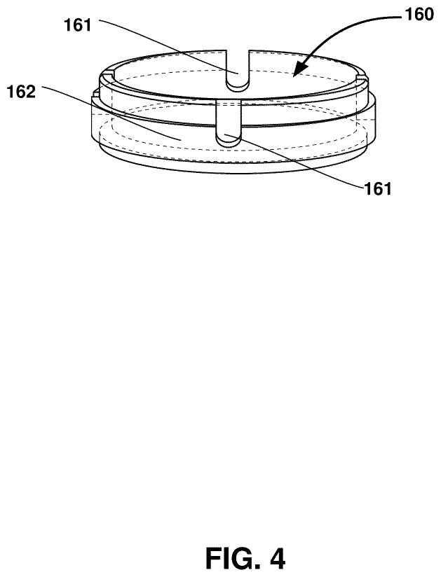

Referring to FIG. 1 and FIG. 4, the base 160 is configured to provide a support surface for the cleaning tool 100 when the cleaning tool 100 is not in use that is, in a stored position. The base 160 is further configured to keep the cleaning tool 100 in a stored position as seen in FIG. 1 when the cleaning tool 100 is not in use that is, in a stored position. The base 160 comprises a plurality of ventilation holes 161 to prevent moisture buildup in the cleaning tool 100. The base 160 has a rib textured surface area that is used to brush off the excess coffee material from the receptacle 150. The base 160 includes a collar 162 that supports the load (weight) placement of the cleaning tool 100. In an embodiment, the base 160 has a texture that removes coffee material from the cleaning element 130 to prevent build-up of coffee material by a brushing motion. The texture of the base 160 may be made of materials such as but not limited to textile, nylon, rubber, and so on. In another embodiment (not shown in figures), the receptacle 150 and the texture of the base 160 are made of two distinct materials such that the texture of the base 160 is removably connected to the receptacle 150. The receptacle 150 and the base 160 may be removably connected or integrally connected to each other.

In an embodiment as seen in FIG. 1 and FIG. 4, the plurality of ventilation holes 161 is U-shaped in nature. In another embodiment (not shown in figures), the plurality of ventilation holes 161 may have another shape including but not limited to: circle, oval, triangular, square, rectangle, V-shape, and so on.

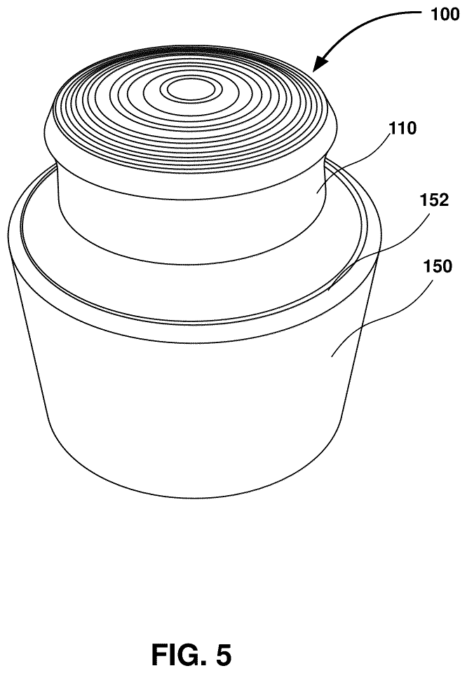

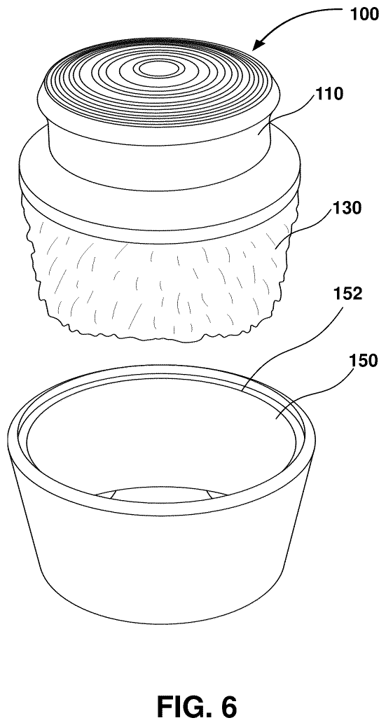

FIG. 5 illustrates a front perspective view of a cleaning tool 100, according to another embodiment of the invention, wherein the cleaning tool 100 is shown as not in use. The storage receptacle 150 is a cylindrical element that is used for convenient and sanitary storage of the cleaning tool 100 when the cleaning tool 100 is not in use. FIG. 6 illustrates a front perspective view of a cleaning tool 100, wherein the cleaning tool 100 is shown disengaged from the storage receptacle 150. The receptacle 150 includes a top groove 152 that securely holds the handle 110 in a stored position, preventing it from slipping or falling.

FIG. 7 illustrates a front perspective view of a cleaning tool 100 effectively cleaning a portafilter basket 210, wherein the storage receptacle 250 is positioned adjacent to the cleaning tool 100. As seen in FIG. 7, the portafilter basket 210 is connected to a portafilter handle 220 such that the portafilter basket 210 and the portafilter handle 220 collectively define a portafilter 230.

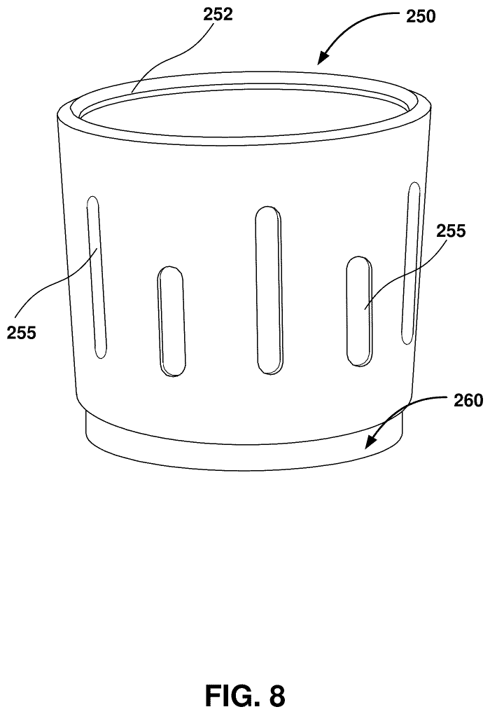

FIG. 8 illustrates a front perspective view of a receptacle 250 of the cleaning tool 100, according to another embodiment of the invention. The receptacle 250 is substantially hollow cylindrical in shape and includes a plurality of cut-out holes 255 to prevent moisture buildup in the cleaning tool 100. The receptacle 250 includes a top groove 252 that securely holds the handle 110 in a stored position, preventing it from slipping or falling.

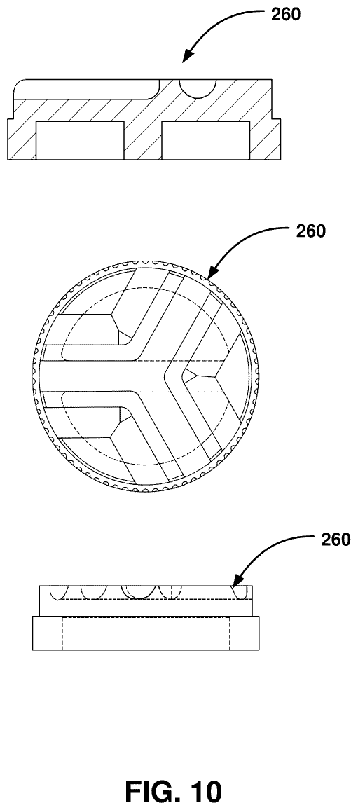

FIG. 10 illustrates various views of a base 260, according to another embodiment of the invention. The base 260 is formed of a substantially rigid material such as but not limited to: plastic and so on and has a cleaning texture that enables the user to brush (clean) the cleaning element 130 against the surface of base 260 to knock off coffee ground build up should it occur after multiple uses of the cleaning tool 100. The base 260 may act as a stand-alone unit or alternatively, the base 260 may be nested inside the receptacle (150, 250).

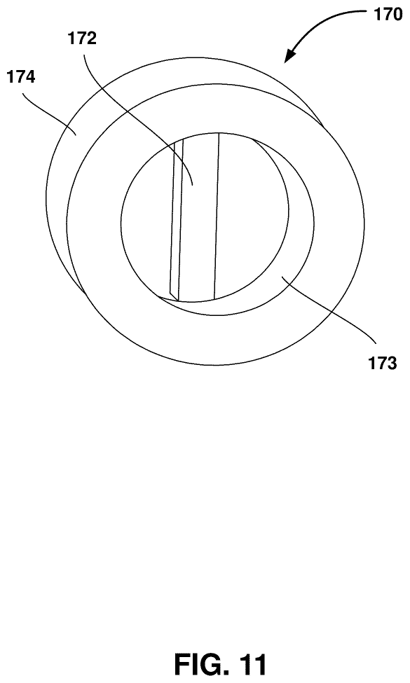

FIG. 11 illustrates a front sectional view of an attachment 170, according to an embodiment of the invention. The attachment 170 is formed of a material such as but not limited to rubber. The attachment 170 is removably connected (screwed/snapped) to the mandrel 120 to define (form) the “core” of the cleaning tool 100 which is substantially cylindrical in shape. The attachment 170 includes a protrusion 172 that is configured to be received in the cutout 125 of the mandrel 120 for effective locking. The attachment 170 includes an inner surface 173 that is connected to a connection surface 121 of the mandrel 120. Further, the attachment 170 includes an installation surface 174 that supports installation of the cleaning tool 130.

The assembly process of the cleaning tool 100 involves connecting an attachment 170 by any means such as but not limited to: screwing, snapping and so on onto the mandrel 120 to create the substantially cylindrical central “core”, which is then inserted into the cleaning element 130. The cleaning element 130 in the form of microfiber cloth is worn on the installation surface 174 of the attachment 170 and the installation surface 126 of the mandrel 120, wherein the installation surface 174 of the attachment 170 and the installation surface 126 of the mandrel 120 collectively defines the outer surface of the “core”. The handle 110 is subsequently screwed onto the mandrel 120, securing the cleaning element 130 in place on the core by clamping its top edges between handle 110 and mandrel 120. Once fully assembled, cleaning tool 100 is ready for use. Additionally, the invention comprises a receptacle (150, 250) to store the cleaning tool 100 when not in use. The receptacle (150, 250) includes a top groove (152, 252) that securely holds the handle 110 in place in a stored position, preventing it from slipping or falling. Moreover, the base (160, 260) may be nested inside the receptacle (150, 250) or the base (160, 260) may function as a standalone unit. The base (160, 260) serves to remove coffee ground buildup from cleaning element 130 during the cleaning process, enhancing the efficacy of the cleaning tool 100.

An exemplary method of using the cleaning tool 100 for cleaning the portafilter basket 210 (FIG. 7) will now be described in reference to FIGS. 1-11.

Initially, the cleaning tool 100 is positioned in a semi-assembled position by placing the receptacle 150 over the cleaning element 130, wherein the cleaning element 130 is installed the installation surface 174 of the attachment 170 and the installation surface 126 of the mandrel 120. Afterward, the handle 110 is removably connected to the mandrel 120 to define the cleaning tool 100. Initially, the cleaning tool 100 is placed in the receptacle 150 in the stored position.

To initiate the cleaning process of the portafilter basket 210, the portafilter basket 210 is detached from the espresso machine (not shown in the figures). Then, the used coffee puck is removed from the portafilter basket 210. Afterwards, the user grips the handle 110 of the cleaning tool 100 to lift the cleaning tool 100 relative to the receptacle 150. Afterward, the user manipulates (moves) the handle 110 such that the cleaning element 130 of the cleaning tool 100 is inserted inside the dirty portafilter basket 210 and thereby contact with the dirty portions of the dirty portafilter basket 210. The cleaning tool 100 is moved in the dirty portafilter basket 210 to clean the dirty portafilter basket 210. The movement of the cleaning tool 100 relative to the dirty portafilter basket 210 may be rotational movement, sliding movement and/or combinations thereof. Thus, the portafilter basket 210 is cleaned effectively due to the rotating and/or sliding motion of the cleaning tool 100. Afterward, the user grips the handle 110 of the cleaning tool 100 and then manipulates (moves) the handle 110 such that the cleaning tool 100 is placed inside the receptacle (150, 250) and/or the base (160, 260) as seen in FIG. 1.

The cleaning tool 100 of the present invention is primarily used for cleaning portafilter basket 210 (FIG. 7) of the typical espresso machine. However, it should be obvious to the one skilled in the art that the cleaning tool 100 may be used for other purposes involving cleaning such as but not limited to: coffee machines, vehicle cleaning, filter cleaning, dust cleaning brush, bath brush, oven cleaning and so on. Broadly speaking, the cleaning tool 100 may be used to serve any purpose related to cleaning a surface having dirt residue on it.

In an embodiment, the cleaning tool 100 of the present invention is substantially made of metals/metal alloys such as but not limited to: steel, Aluminum, copper, iron, and so on. In another embodiment, the majority of the cleaning tool 100 of the present invention is substantially made of non-metals such as but not limited to: plastics, wood, ceramics, and so on. Further, it should be understood that the material of the cleaning tool 100 is non-limiting and should not be construed as a limiting factor in defining the scope of the present invention. For instance, the material of the cleaning tool 100 may include but not be limited to silicon, textile, Fiber, and so on. It should be obvious that after cleaning the portafilter basket 210 (FIG. 7), the cleaning tool 100 may itself be washed with a cleaning liquid such as soap solution, detergent, water, etc. Further, the cleaning tool 100 can be adapted to serve as a brush, a squeegee, or a felt/fabric cylinder when attached to a shaft capable of manual or motorized rotation. This configuration enables diverse cleaning techniques, providing flexibility in addressing various debris compositions and cleaning requirements of the portafilter basket 210 (FIG. 7).

Although particular embodiments of the invention have been described in detail for purposes of illustration, various modifications, and enhancements may be made without departing from the spirit and scope of the invention.

What is claimed is:

1. A cleaning tool (100) for cleaning a portafilter basket (210) of a coffee machine; the cleaning tool (100) comprising:
a handle (110) that includes a gripping surface (111) capable of being manually grasped by a user;
a mandrel (120) removably connected to the handle (110), wherein the mandrel (120) includes an installation surface (126) configured for placement of a cleaning element (130);
an attachment (170) connected to the mandrel (120), wherein the attachment (170) includes an installation surface (174) for the installation of the cleaning tool (130); and
a receptacle (150, 250) that is configured for storage of the cleaning tool (100) when the cleaning tool (100) is in a stored position.

2. The cleaning tool (100) according to claim 1, wherein the receptacle (250) includes a plurality of cut-out holes (255) to prevent moisture buildup in the cleaning tool (100).

3. The cleaning tool (100) according to claim 1, wherein the cleaning tool (100) further includes a base (160, 260) that includes a cleaning texture that enables the user to brush the cleaning element (130) against the surface of the base (160, 260) to knock off the coffee ground buildup.

4. The cleaning tool (100) according to claim 1, wherein the cleaning element (130) is a microfiber cloth that is stitched in shape along stitch lines (132).

5. The cleaning tool (100) according to claim 1, wherein the cleaning element (130) includes a cylindrical element formed of a material selected from a group consisting of terrycloth, nylon bristles, brush, steel wires, polyester brush, and cotton.

6. The cleaning tool (100) according to claim 1, wherein the mandrel (120) includes a central opening (122) that is configured to be removably connected to a cylindrical connecting element (112) of the handle (110).

7. The cleaning tool (100) according to claim 1, wherein the mandrel (120) further includes an annular wedge element (123).

8. The cleaning tool (100) according to claim 1, wherein the attachment (170) includes a protrusion (172) that is configured to be received in the cutout (125) of the mandrel (120).

9. The cleaning tool (100) according to claim 1, wherein the receptacle (150, 250) includes a top groove (152, 252) that securely holds the handle (110) in place in a stored position.

10. The cleaning tool (100) according to claim 1, wherein the receptacle (150, 250) is made from an absorbent material.

11. The cleaning tool (100) according to claim 1, wherein the base (160) comprises a plurality of ventilation holes (161) to prevent moisture buildup in the cleaning tool (100).

12. The cleaning tool (100) according to claim 1, wherein the base (160) includes a collar (162) that supports load placement of the cleaning tool (100).

13. The cleaning tool (100) according to claim 1, wherein the mandrel (120), the cleaning element (130), and the attachment (170) are integrally formed to define a unitary one-piece structure.
